(19) United States
(12) Patent Application Publication
(10) Pub. No.: US 2005/0110442 A1
(43) Pub. Date: May 26, 2005

(54) Torque ripple and audible noise reduction in an electric machine

(75) Inventor: Timothy M. Trifilo, Walden, NY (US)

Correspondence Address: Philmore H. Colburn II;Cantor Colburn LLP, 55 Griffin Road South, Bloomfield, CT, 06002, US

(73) Assignee: INTERNATIONAL BUSINESS MACHINES CORPORATION, ARMONK, NY (US)

(21) Appl. No.: 10/719,473

(22) Filed: Nov. 21, 2003

(51) Int. Cl. H02P 5/06

(52) U.S. Cl. 318/254

(57) ABSTRACT

A method to reduce torque ripple and audible noise in an electric machine, the method comprising: initiating a rotation of said electric machine at a determinable velocity; detecting at least one phase voltage signal indicative of a back electromotive force (BEMF); synthesizing at least one waveform indicative of the BEMF; and scaling a command to the electric machine based on the at least one waveform. A system to reduce torque ripple and audible noise in an electric machine comprising: an electric machine in operable communication with a control circuit configured to generate a voltage command to control each phase of the electric machine and including a controller. The controller is configured to: detect at least one phase voltage signal indicative of a back electromotive force (BEMF); synthesize at least one waveform indicative of the BEMF; and scale a command to the electric machine based on the at least one waveform.

### BACKGROUND OF THE INVENTION

The present invention relates generally to electronically commutated DC motors (i.e., brushless DC motors) and, more particularly, to a system and method to synthesize a waveform to reduce torque ripple and acoustic emissions.

Brushless direct current (BLDC) motors are well known in the art. The phase windings in these motors are sequentially energized at appropriate times so as to produce a rotating magnetic field relative to a permanent magnet rotor. The timing of such energization is a function of where the permanent magnetic rotor is relative to a phase winding that is to be energized. Various means have been heretofore used to sense the position of the permanent magnet rotor relative to the phase windings. These have included optical sensors and Hall effect devices which feed a position signal to switching logic that selectively switches power on and off to the respective phase windings. However, such sensing devices add cost and complexity to a system, and may moreover require maintenance from time to time to assure continued proper operation. In certain high flux/power applications, such as those employing 350 volt motors, the Hall sensors are a common point of failure. As a result, of these drawbacks, attention has recently been focused on “sensorless” systems, which are not premised on any direct sensing of the rotor position itself. These systems generally attempt to measure the effect of the back electromotive forces produced in the energized windings by a rotating rotor. These systems have achieved various degrees of success in accurately measuring the effect of this back electromotive force.

In addition, competing interests in motor design face conflicting requirements. Requirements for more speed and/or power often conflict with acoustic considerations. Higher power generally means higher torque ripple. Increased torque ripple often means that a motor is louder and may emit audible noise. One solution widely employed to address torque ripple and audible noise involves “rounding” the edges of the square waves that drive the brushless DC machine during each commutation subinterval. This significantly reduces acoustic emissions, at the expense of not achieving the full torque output of the motor in use.

Thus, it is desired to drive brushless DC motors exhibiting high torque and without unpleasant acoustic emissions at low frequencies in the audible range.

### SUMMARY OF THE INVENTION

The shortcomings of the prior art are overcome and additional advantages are provided through the provision of a method to reduce torque ripple and audible noise in an electric machine, the method comprising: initiating a rotation of said electric machine at a determinable velocity; detecting at least one phase voltage signal indicative of a back electromotive force (BEMF) for a selected phase; synthesizing at least one waveform indicative of the BEMF for each phase of the electric machine; and scaling a command to the electric machine based on the at least one waveform.

Also disclosed herein in another exemplary embodiment is a system to reduce torque ripple and audible noise in an electric machine comprising: an electric machine in operable communication with a control circuit; the electronic control circuit configured to generate a voltage command to control each phase of the electric machine and including a controller. The controller is configured to: detect at least one phase voltage signal with the electric machine rotating at a determinable speed, yet unexcited, indicative of a back electromotive force (BEMF) for a selected phase; synthesize at least one waveform indicative of the BEMF for each phase of the electric machine; and scale a command to the electric machine based on the at least one waveform.

Further disclosed herein in yet another exemplary embodiment is a storage medium encoded with a machine-readable computer program code, said code including instructions for causing a computer to implement the abovementioned method to reduce torque ripple and audible noise in an electric machine.

### BRIEF DESCRIPTION OF THE DRAWINGS

Referring to the exemplary drawings wherein like elements are numbered alike in the several Figures:

FIG. 1 is a schematic diagram of a control circuit for a sensorless brushless DC motor in operable communication with a three-phase inverter configured to maintain consistent phase and device nomenclature in accordance with an exemplary embodiment of the invention;

FIG. 2 is a diagram illustrating an ideal waveshape for the BEMF of a motor;

FIG. 3 is a diagram illustrating an ideal waveshape for the BEMF of a motor including clamping;

FIGS. 4A and 4B depict measured BEMF waveforms for two existing motors;

FIG. 5 depicts a simplified block diagram of a motor control system of FIG. 1 including the processes of an exemplary embodiment; and

FIG. 6 is a diagram illustrating a waveshape for the BEMF of a motor exhibiting the effects of a reduction of motor speed.

### DETAILED DESCRIPTION OF THE INVENTION

Disclosed herein in an exemplary embodiment is a method and system reducing torque ripple and audible noise. In an exemplary embodiment, the motor back electromotive force (BEMF) characteristic is sampled and processed to formulate an envelope to modulate the motor drive waveforms to facilitate optimal commutation. The method and system involves synthesizing a drive waveform envelope for the motor BEMF each time the motor starts and employing the synthesized waveform to compensate motor voltage commands for variations including, but not limited to, thermal variation, magnet aging, and even cracked magnets. In an exemplary embodiment, during the start up of the motor, it is stepped in open loop mode for a selected amount of electrical degrees. Meanwhile the period of the back-EMF waveform and it's magnitude are sampled. It should be appreciated by one skilled in the art that the sampling will depend on the motor construction and characteristic and should be performed to ensure that sufficient resolution is provided to capture and synthesize the waveform.

In an exemplary embodiment, a two stage modulation scheme is employed, one for the speed of the motor, which controlled by pulse width modulation (PWM), the other to provide matching to the BEMF profile. The BEMF profile is multiplied by a scaling coefficient proportional to the speed error signal as derived from existing speed based motor controls, and then the combined command is modulated to drive the motor.

It should be noted that the exemplary embodiments as disclosed herein provide for a reduction in torque ripple and audible noise over existing designs. This is desirable in all applications, and may actually be critical in some application such as medical instrumentation and disk storage systems. In particular, low torque ripple and minimal audible noise are beneficial motor of choice for high power blowers and fans associated cooling critical components, most particularly associated with computers. Moreover, it will readily be appreciated that while the exemplary embodiments described herein are made with reference to a brushless DC motor, the invention is readily applicable with appropriate variation to other motor and motor controller types including, but not limited to, DC, AC, Brush, and Brushless.

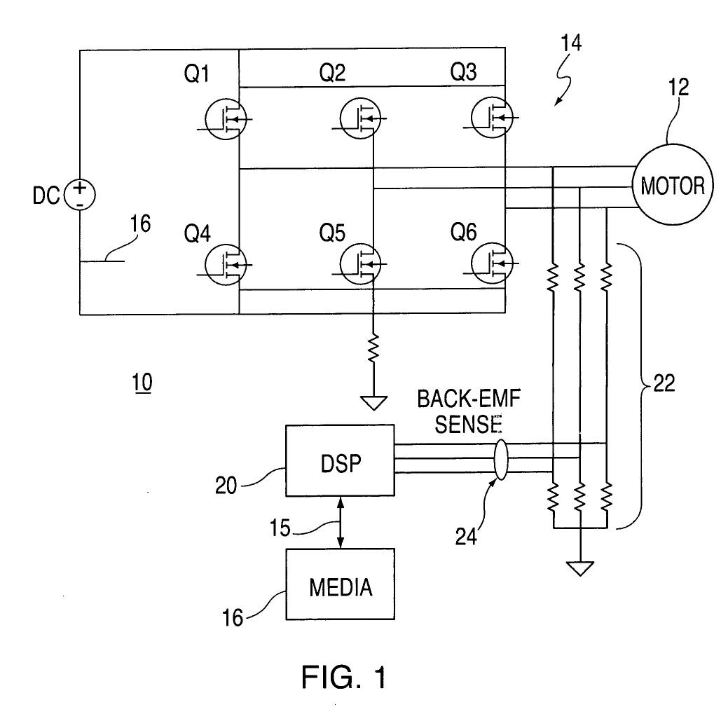

Referring initially to FIG. 1, there is shown a schematic diagram of an existing control circuit 10 for a sensorless brushless DC motor 12. As is well known in the art, an inverter 14 is used to electronically commutate the phase currents supplied by a DC bus 16 to the motor 12. For a motor having three phase windings, a conventional inverter 14 includes six individually controlled switching devices, designated in FIG. 1 as Q1 through Q6. The switching devices Q1 through Q6 may be transistors, junction transistors, Field Effect transistors (FETs), Metal Oxide Field Effect transistors (MOSFETs), Insulated Gate Bipolar Transistors (IGBTs), Silicon Controlled Rectifiers (SCR), and Triacs solid state relays and the like, as well as combinations including at least one of the foregoing. In the example shown, the switching devices are (MOSFETS); however, other types of solid state switching devices may also be used as discussed above.

Q1, Q2, and Q3 selectively couple each of the three motor phases to the positive side of the DC bus 16, while Q4, Q5, and Q6 selectively couple each of the three motor phases to the negative side of the DC bus 16. Each of the MOSFETS are energized and de-energized in a selected sequence as determined by an appropriate control signal applied to the gate terminals thereof. As shown in the figure, there are two transistors of the six in the inverter 14 on at any time, which causes a current to flow in the phase windings of the motor 12. In reality, it will be appreciated that the inverter pulse width modulates the applied voltages and currents to control the average power to the motor 12 and thereby provide speed regulation. In other words, the voltages are applied at some duty cycle proportional to speed error signal within a selected current limit setpoint. It is well known that torque ripple almost always contributes to undesired acoustic emissions and noise and further that the torque is also proportional to current in the motor. Thus, reductions in the torque ripple will also advantageously provide reductions in audible noise. Furthermore, because torque is proportional to current, reduction or elimination of variations in current will similarly result in reductions of torque ripple.

A controller 20, including a microprocessor (e.g., a digital signal processor (DSP) is shown), is used to generate these control signals for energization and de-energization of the motor windings. The controller 20 is employed to develop the correct voltage needed to produce the desired torque, position, and/or speed of the motor 12. In order to perform the prescribed functions and desired processing, as well as the computations therefore (e.g., the control algorithm(s), and the like), the controller 20 may include, but not be limited to, a processor(s), computer(s), memory, storage, register(s), timing, interrupt(s), communication interface(s), and input/output signal interfaces, and the like, as well as combinations comprising at least one of the foregoing. For example, controller 20 may include signal input signal filtering to enable accurate sampling and conversion or acquisitions of such signals from communications interfaces. It should also be appreciated that while in an exemplary embodiment the inverter 14 and controller 20 are described as separate, in some embodiments, it may desirable to have them integrated as a single component as an electronic control circuit. Additional features of controller 20 are thoroughly discussed at a later point herein.

It will be appreciated, that the controller functionality described herein is for illustrative purposes. The processing performed throughout the system may be distributed in a variety of manners. For example, distributing the processing performed in the controller 20 among the other controllers, and/or processes employed may eliminate a need for such a component or process as described. Each of the elements of the systems described herein may have additional functionality as described in more detail herein as well as include functionality and processing ancillary to the disclosed embodiments. As used herein, signal connections may physically take any form capable of transferring a signal, including, but not limited to, electrical, optical, or radio.

As stated previously, one method for addressing the torque ripple and audible noise is to ensure that the drive commands to the motor are synchronized and matched with the BEMF of the motor 12. To accomplish this the de-energized BEMF of the motor 12 under selected conditions is monitored. As shown in FIG. 1, to measure the BEMF of the motor 12, the phase voltages are sensed and measured by a controller 20 after being attenuated to a suitable level for the microprocessor logic. In the example illustrated, a voltage divider 22 attenuates the phase voltages of the motor 12 (having a peak phase voltage of about 450 volts) by about a factor of 130, to result in a peak sensed voltage of about 3.3 volts. Thus, attenuated phase voltage signals 24 are inputted directly into the controller 20. It will be appreciated by one skilled in the art that the attenuation scheme employed herein for measuring the phase voltages is illustrative, other methods and implementations providing similar capability and functionality are possible and readily considered.

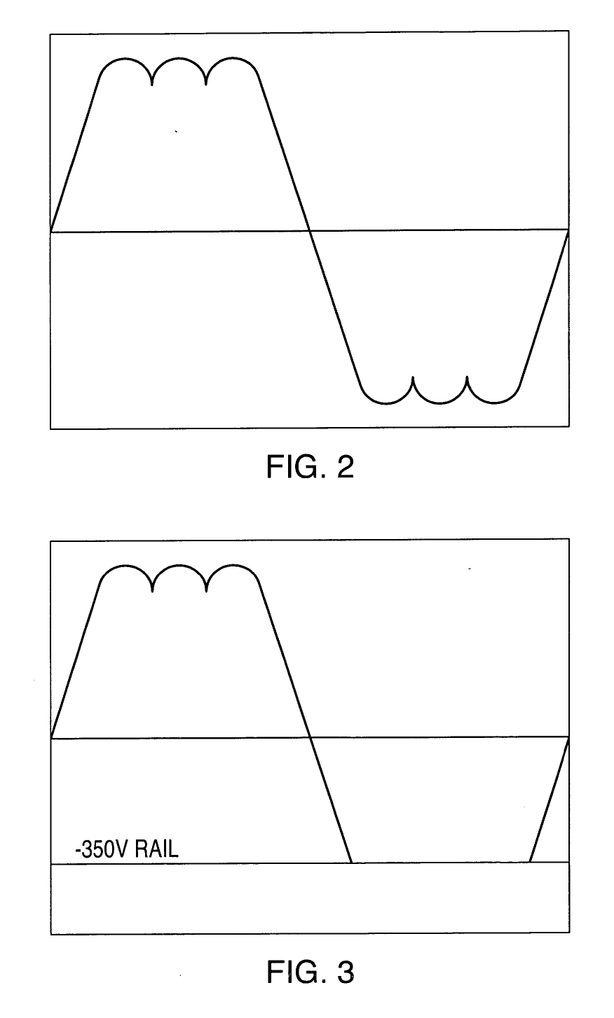

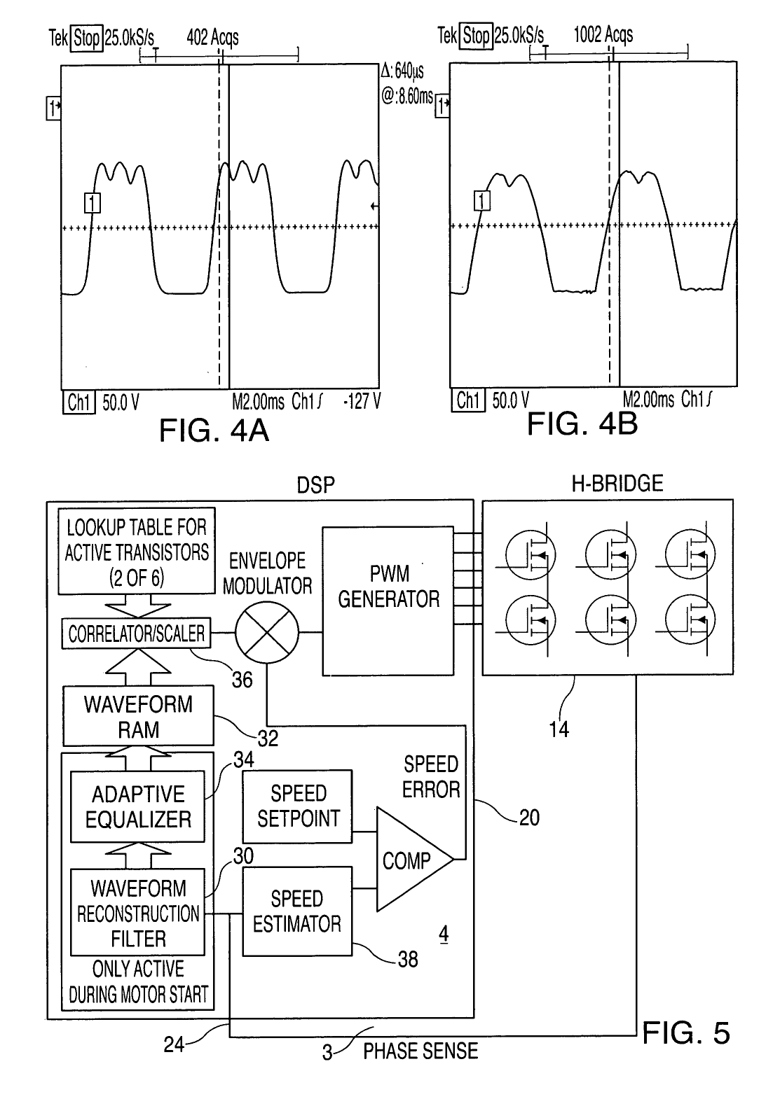

Referring now to FIGS. 2 and 3, it will be appreciated by those skilled in the art that most BLDC motors exhibit a BEMF profile that is somewhat trapezoidal and therefore may be approximated as trapezoidal. FIG. 2 depicts an ideal BEMF waveform. However, with actual magnets exhibiting actual field gradients, the waveshape of the profile for the BEMF is not purely trapezoidal. In addition, when configured in a control circuit 10 as employed in FIG. 1, the wave shape of the BEMF as measured by the circuit 10 via the attenuated phase voltage signals 24 is further reconfigured. FIG. 3 depicts an example of the BEMF waveform including this modification. It is noteworthy to appreciate that the bottom of each waveform as depicted in the figure is substantially flat. This flattening is due to freewheeling diodes on the inverter 14, as the floating phases of he motor 12 get clamped to the ground rail, which is increasing as the bulk caps discharge, in the actual drive, this would be clamped to −350V. It will readily be appreciated that the real BEMF of the motor alone does not exhibit this clamping. FIGS. 4a and 4b depict measured BEMF waveforms for two existing motors for illustration. The figures depict the voltage seen by the drive inverter 14 as the motor 12 rotates freely with no phase drive. These plots were taken just as the motor drive was turned off.

It will be appreciated that optimal efficiency may be achieved if the motor drive commutates the motor 12 with a profile that exactly matches the BEMF profile provided by the motor 12, as this places the voltage and current in phase. Concomitantly, there would also be a great reduction in torque ripple and input current ripple. Torque ripple would still be present (based on the switching employed), however, in this instance, the torque ripple would be at primarily a single frequency. Torque ripple at a single frequency would be substantially easier to damp mechanically, and filter electrically.

Referring once again to FIGS. 2 and 3, and now to FIG. 5 in an exemplary embodiment, to synthesize a waveform for the BEMF, the phase voltage signals 24 are captured, measured and stored. FIG. 5 depicts a simplified block diagram of a motor control circuit 10 of FIG. 1 including the processes of an exemplary embodiment integrated with existing speed control. Moreover, in an exemplary embodiment, the symmetry in the configuration motor 12 is further considered and exploited to simplify the synthesis. Advantageously it will be appreciated that motor symmetry is readily taken as given, because the motor 12 is always designed as a symmetric device. Each magnet (note that it is substantially a magnet profile that is to be sampled) will pass each of the phase windings in a single electrical period. Therefore, there is enough data available in the phase voltage signals 24 to verify the symmetry of the motor 12 and more specifically the magnets. By sampling all three phases, during this time, compensation for uneven winding counts, broken magnets, or even asymmetrically magnetized motors may readily be realized.

This approach provides a methodology for synthesizing individual full period wave shapes for each motor phase that may be employed for the modulation and control of the voltage commands to the motor 12. Advantageously an exemplary embodiment of the invention facilitates the waveform capture/synthesis by taking advantage of the symmetry of the motor 12, and therefore the BEMF waveforms, by capturing less than all of the phase voltage signals 24 and utilizing the captured information to synthesize the waveforms for other non-captured phases. It will also be appreciated that by considering the symmetry of the motor 12, the BEMF wave forms may be synthesized capturing as little as one half of the positive period for a single phase, and/of capturing the full waveform for each of the three phases. Advantageously, the first approach utilizes the least memory and exhibits the shortest sampling duration but is computationally the most extensive, while the latter approach requires significant storage and a longer duration, but utilizes minimal computation. It will also be appreciated that other approaches between these “extremes” are possible and considered. For example, in an exemplary embodiment, the positive portion for two phase voltage signals 24 are sampled and measured. This tradeoff providing a compromise between sampling duration, memory allocation, and computational intensity.

Therefore, once again with reference to FIG. 5, in an exemplary embodiment, the BEMF waveforms may be synthesized with a reconstruction filter 30 employing the following relationship that considers the multiphase characteristics of the motor 12 and its construction symmetry. For example, it will be appreciated that the waveforms may be synthesized by:

Capturing and measuring the positive portion of the phase voltage signal 24 for phase A. Capturing and measuring the positive portion of the phase voltage signal 24 for phase B. Negating the phase B positive portion and shifting the resultant in time, advanced 60 electrical degrees to complete that magnets profile for the phase A signal. Therefore, in other words: for phase A, for the interval of 0-180 degrees, the waveform is defined by the phase A voltage signal; for the interval of 180-360 degrees, the BEMF waveform for phase A is defined as the negative of the positive portion of the phase B waveform shifted 60 electrical degrees and concatenated with the 0-180 degree portion. The profile for the phase A waveform may readily be stored in memory 32. This completes the profile for phase A, as the magnet 1, has now passed to the next phase pair, which is wired opposite polarity. Adjacent legs of the stator are wired out of phase.

Similarly, for phase B, apply the above transform and subtract 120 electrical degrees. Likewise, for phase C, apply the above transform and subtract 240 electrical degrees. Similarly, the completed profiles for phases B and C may be stored in memory 32.

It will be appreciated that while there are more magnets, the BEMF is substantially a composite corresponding to the integer multiple of legs and magnets the specific motor design employs. It will be appreciated as well, that the described methodology while not computationally intensive, does require an acquisition buffer that is on the order of several Kilobytes for a motor operating at low speeds.

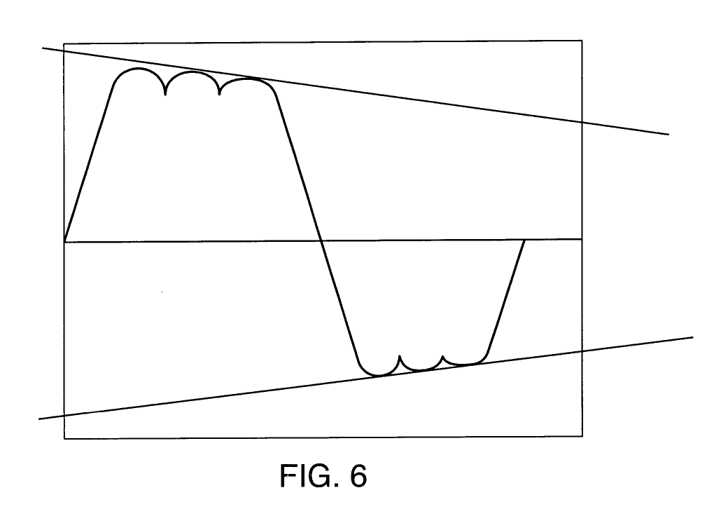

Application of the abovementioned methodology gives rise to a second consideration. While the phase voltage signals 24 are captured and measured as described herein, the motor 12, because it is not being driven, is slowing down during the duration of the sampling. The magnitude and frequency of the BEMF are proportional to the speed of the motor 12. Thus, when the speed of the motor is decreasing, the magnitude and frequency of the BEMF is decreasing. FIG. 6 provides and illustrative depiction of the variation in the BEMF from the ideal depicted in FIG. 2.

In yet another exemplary embodiment, an optional equalizer/normalizer 34 may be employed on the sampled BEMF waveform data after it is reconstructed by the algorithm presented above to compensate for this variation as a function of the motor speed. The equalizer/normalizer may be as simple as magnitude compensation and normalization, or as complex as an adaptive equalizer with compensation for adjacent phase noise. If a more complex equalization were desired, this could be done spectrally (in the frequency domain, with greater accuracy, a finite impulse response (FIR) or infinite impulse response (IIR) method). In one exemplary embodiment a finite impulse response (FIR) or infinite impulse response (IIR) equalizer is employed to address magnitude and spectral compensation. Advantageously, since the processing described herein for the exemplary embodiments is only completed once for the entire dataset, e.g., upon each startup, executing an equalizer function is not that significant a load on the CPU. Once again, following equalization/normalization, the normalized BEMF waveforms may be saved and stored in memory 50.

The following illustration depicts an application of the exemplary embodiments. The motor start sequence includes a series of open loop commutation pulses, to start the motor 12 is spinning at some low speed. At this time, the all three phases are sampled, capturing the phase voltage signals 24 and a waveform profile is stored in memory 34. It will be appreciated that this captured waveform data is “one-sided” as the motor drive (inverter 14) clamps the phases voltage signals 24 to the ground rail as described earlier. The abovementioned algorithm and methodology may then be employed to perform the reconstruction and establish an array or table with each of the values associated with the reconstructed BEMF waveforms. The reconstruction 30 employs the trigonometric and linear transforms described above to extract and synthesize the magnetic profile for all three phases.

After the initial start up commutation pulses, the motor 12 is unexcited and begins to slow. The BEMF waveform is then decreasing in amplitude as motor speed decreases. This is a linear decrease, as BEMF is linearly proportional to motor speed. This rate of decrease can be used to create a gradient vector that may be utilized to normalize and equalize 34 all sampled array elements to a uniform magnitude and frequency. In one exemplary embodiment, a unity magnitude and period are employed for simplicity. This methodology is repeated for the reconstruction of all three phases.

Continuing with FIG. 6, central to creating a signal of varying frequency and amplitude to drive the motor 12 is the correlator/scaler 36. The BEMF waveforms stored in memory 32 include an image of the waveform at one frequency only (corresponding to an initial selected motor speed), and at the maximal amplitude. The correlator/scaler 36 is employed to employ the existing commutation state, (associated with existing speed control) as reference, and map the stored BEMF waveform period to a length corresponding the existing speed of the motor 12. The scale associated with the mapping may readily determined by the speed estimator 38 based on the current motor speed relative to the initial motor speed at which the BEMF waveforms were sampled. Said another way, the period of the synthesized phase waveform for each phase is scaled in time to equal the period of the PWM for a given commutation state. In an exemplary embodiment, the scaling is accomplished with a correlator or piecewise linear/polynomial interpolation algorithm.

It will be appreciated, that at this point the PWM waveform of the shape of the motor back-EMF, at the appropriate frequency for the current motor speed, but at maximum amplitude. The final process is to scale the magnitude based upon the current motor speed (since the BEMF waveform were previously magnitude normalized) at modulator 40. The modulator received the correlated and frequency scaled BEMF waveform, which is then employed to modulate the existing speed control. The speed regulator shown generally as 42 computes this scaling factor proportional to the speed error signal. The speed control employed may be of various configurations including, but not limited to proportional, proportional-integral (PI), proportional-derivative (PD), proportional-integral-derivative (PID), and the like.

It will be appreciated that each element of the equalized, time-scaled BEMF waveform is amplitude scaled in real time. Advantageously, this means is that as the motor 12 changed speed during commutation sub-intervals the corrections to the BEMF waveforms are scaled as well. In addition, it will be appreciated that the approach employed provides a significant memory savings, as one “master” copy of the three BEMF phase waveforms, and one small buffer for each commutation sub-interval per active phase need be stored. This real-time scaling is preferred as it is most flexible and memory efficient, however, scaling the waveforms in advance could also be utilized.

The system and methodology described in the numerous embodiments hereinbefore provides a robust means to reduce torque ripple and audible noise. In addition, the disclosed invention may be embodied in the form of computer-implemented processes and apparatuses for practicing those processes. The present invention can also be embodied in the form of computer program code containing instructions embodied in tangible media 16, such as floppy diskettes, CD-ROMs, hard drives, or any other computer-readable storage medium, wherein, when the computer program code is loaded into and executed by a computer 20, the computer 20 becomes an apparatus for practicing the invention. The present invention can also be embodied in the form of computer program code, for example, whether stored in a storage medium, loaded into and/or executed by a computer, or as data signal 15 transmitted whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method to reduce torque ripple and audible noise in an electric machine, the method comprising:
initiating a rotation of said electric machine at a determinable velocity;
detecting at least one phase voltage signal indicative of a back electromotive force (BEMF) for a selected phase;
synthesizing at least one waveform indicative of said BEMF for each phase of said electric machine; and
scaling a command to said electric machine based on said at least one waveform.

2. The method of claim 1 further including equalizing said at least one waveform to compensate for magnitude and frequency variations therein.

3. The method of claim 1 further including storing said at least one waveform in memory to facilitate later computations.

4. The method of claim 1 further including compensating said at least one waveform to correlate its frequency to that of a command associated with a selected operational speed of said electric machine.

5. The method of claim 1 further including compensating said at least one waveform to correlate its magnitude to that of a command associated with an operational speed of said electric machine.

6. The method of claim 5 wherein said compensating includes modulating said command based on said at least one waveform.

7. The method of claim 1, wherein when the electric machine is connected to the electronic control circuit, the electronic control circuit is operative to control the electric machine having one or more magnetic components.

8. The method of claim 7, wherein the electric machine is a brushless DC (BLDC) motor and the electronic control circuit includes at least four inverter transistors configured to operate said motor.

9. The method of claim 1, wherein said command is configured to control said electric machine to maintain speed.

10. A system to reduce torque ripple and audible noise in an electric machine comprising:
an electric machine in operable communication with a control circuit;
said electronic control circuit configured to generate a voltage command to control each phase of said electric machine and including a controller; and
wherein said controller is configured to: detect at least one phase voltage signal with said electric machine rotating at a determinable speed, yet unexcited, indicative of a back electromotive force (BEMF) for a selected phase; synthesize at least one waveform indicative of said BEMF for each phase of said electric machine; and scale a command to said electric machine based on said at least one waveform.

11. The system of claim 10 further including said controller equalizing said at least one waveform to compensate for magnitude and frequency variations therein.

12. The system of claim 10 further including said controller storing said at least one waveform in memory to facilitate later computations.

13. The system of claim 10 further including said controller compensating said at least one waveform to correlate its frequency to that of a command associated with a selected operational speed of said electric machine.

14. The system of claim 10 further including said controller compensating said at least one waveform to correlate its magnitude to that of a command associated with an operational speed of said electric machine.

15. The system of claim 14 wherein said compensating includes modulating said command based on said at least one waveform.

16. The system of claim 10, wherein when the electric machine is connected to the electronic control circuit, the electronic control circuit is operative to control the electric machine having one or more magnetic components.

17. The system of claim 16, wherein the electric machine is a brushless DC (BLDC) motor and the electronic control circuit includes at least four inverter transistors configured to operate said motor.

18. The method of claim 10, wherein said command is configured to control said electric machine to maintain speed.

19. A storage medium encoded with a machine-readable computer program code, said code including instructions for causing a computer to implement a method to reduce torque ripple and audible noise in an electric machine, the method comprising:
initiating a rotation of said electric machine at a determinable velocity;
detecting at least one phase voltage signal indicative of a back electromotive force (BEMF) for a selected phase;
synthesizing at least one waveform indicative of said BEMF for each phase of said electric machine; and
scaling a command to said electric machine based on said at least one waveform.
